(19) United States
(12) Patent Application Publication
(10) Pub. No.: US 2015/0046336 A1
(43) Pub. Date: Feb. 12, 2015

(54) SYSTEM AND METHOD OF USING A SECONDARY SCREEN ON A MOBILE DEVICE AS A SECURE AND CONVENIENT TRANSACTING MECHANISM

(71) Applicant: MasterCard International Incorporated, Purchase, NY (US)

(72) Inventor: Oran CUMMINS, Knocklyon (IE)

(73) Assignee: MasterCard International Incorporated, Purchase, NY (US)

(21) Appl. No.: 13/963,203

(22) Filed: Aug. 9, 2013

(51) Int. Cl. G06Q 20/32; G06Q 20/38; G06Q 20/36

(52) U.S. Cl. CPC G06Q 20/322; G06Q 20/367; G06Q 20/3829
USPC 705/65; 705/41

(57) ABSTRACT

A method and system for transmitting payment credentials that are related to a payment account and include at least an account number associated with the related payment account. Machine-readable code is encoded with the set of payment credentials related to the indicated payment account and is displayed on a second display of the mobile communication device. The second screen can be a low-power display, such as electrophoretic display, and the machine readable code can be selectively or continuously displayed.

### FIELD

The present disclosure relates to the transmitting of account credentials using a mobile device, specifically encoding a machine readable code displayed via a second screen of a mobile device with account credentials to be used in conducting a transaction.

### BACKGROUND

Mobile devices that include electronic wallet application programs are gaining widespread use as an alternative to traditional wallets and physical payment cards. Electronic wallets can offer consumers a number of benefits over traditional physical payment cards, such as added security and the ability to store offers or coupons along with payment cards in addition to greater convenience and efficiency. Generally, mobile devices equipped to provide payment credentials typically use near field communication to transmit the credentials to a point of sale system, and sometimes also utilized Secure Elements (i.e., special, tamper resistant, encrypted chips that reside on the motherboards of smartphones and other mobile devices storing data not accessible to the operating system of the mobile device but rather is delivered and extracted by a trusted service manager (TSM)) included within the mobile device to store payment information.

However, near field communication can require a significant amount of power to operate. As a result, the transmission of payment credentials via near field communication often needs to be triggered by the user of the mobile device, which can take a significant amount of time. Further, the use of near field communication can greatly limit battery life of mobile devices, and also cannot be used when a mobile device is at low power or has been turned off. In addition, the utilization of both near field communication or Secure Elements in a mobile device often requires cooperation with the device manufacturer and/or the developer of the operating system of the mobile device, leading to other technical challenges.

Thus, there is a need for a technical solution to provide for the transmission of account credentials using a mobile device that can be more easily developed and operate in low- or no-power environments while maintaining security.

### SUMMARY

The present disclosure provides a description of systems and methods for the transmission of account credentials using a mobile device.

A method for transmitting account credentials includes: storing, in a database, at least one set of account credentials, wherein each of the at least one set of account credentials is related to an account and includes at least an account number associated with the related account; displaying, on a first display of a mobile communication device, an account listing including each account related to each set of account credentials of the at least one set of account credentials; receiving, by an input device, an indication of an account to be used to conduct a transaction; identifying, by a processing device, a machine-readable code, wherein the machine-readable code is encoded with the set of account credentials related to the indicated account; and displaying, on a second display of the mobile communication device, the machine-readable code.

A method for transmitting account credentials via a machine-readable code includes: storing, in a database, at least one account profile, wherein each account profile is related to an account and includes at least account credentials and a single use key, the single use key including at least an application transaction counter and a generating key; displaying, on a display of a mobile communication device, an account listing including each account related to each account profile of the at least one account profile; receiving, by an input device, an indication of an account to be used to conduct a transaction; generating, by a processing device, a transaction cryptogram valid for the transaction based on at least the single use key included in the account profile related to the indicated account; identifying, by the processing device, a machine-readable code, wherein the machine-readable code is encoded with at least the account credentials included in the account profile related to the indicated account and the generated transaction cryptogram; and displaying, on the display of the mobile communication device, the identified machine-readable code.

Another method for transmitting account credentials via a machine-readable code includes: storing, in a database, at least one account profile, wherein each of the at least one account profile is related to an account and includes at least an integrated circuit card (ICC) public key certificate, an issuer public key certificate, and a mapped account number based on attributes of a real account number associated with the account; displaying, on a display of a mobile communication device, an account listing including each account related to each account profile of the at least one account profile; receiving, by an input device, an indication of an account to be used to conduct a transaction; generating, by a processing device, a transaction cryptogram valid for the transaction based on at least one of the ICC public key certificate and issuer public key certificate included in the account profile related to the indicated account; identifying, by the processing device, a machine-readable code, wherein the machine-readable code is encoded with at least the mapped account number included in the account profile related to the indicated account and the generated transaction cryptogram; and displaying, on the display of the mobile communication device, the identified machine-readable code.

Yet another method for transmitting account credentials via a machine-readable code includes: storing, in a database, a public key and at least one set of account credentials, wherein each set of account credentials is related to an account and includes at least an account number associated with the related account, and the public key corresponds to a private key of an RSA key pair; displaying, on a display of a mobile communication device, an account listing including each account related to each set of account credentials of the at least one set of account credentials; receiving, by an input device, an indication of an account to be used to conduct a transaction; encrypting, by a processing device, the account number included in the set of account credentials related to the indicated account using the public key; identifying, by the processing device, a machine-readable code, wherein the machine-readable code is encoded with the encrypted account number; and displaying, on the display of the mobile communication device, the identified machine-readable code.

A mobile communication device for transmitting account credentials includes a database, a first display, an input device, a processing device, and a second display. The database is configured to store at least one set of account credentials, wherein each of the at least one set of account credentials is related to an account and includes at least an account number associated with the related account. The first display is configured to display an account listing including at least one account related to each set of account credentials of the at least one set of account credentials. The input device is configured to receive an indication of an account to be used to fund a financial transaction. The processing device configured to identify a machine-readable code, wherein the machine-readable code is encoded with the set of account credentials related to the indicated account. The second display is configured to display the machine-readable code.

A mobile communication device for transmitting account credentials via a machine-readable code includes a database, a display, an input device, and a processing device. The database is configured to store at least one account profile, wherein each account profile is related to an account and includes at least account credentials and a single use key, the single use key including at least an application transaction counter and a generating key. The display is configured to display an account listing including each account related to each account profile of the at least one account profile. The input device is configured to receive an indication of an account to be used to conduct a transaction. The processing device is configured to: generate a transaction cryptogram valid for the transaction based on at least the single use key included in the account profile related to the indicated account; and identify a machine-readable code, wherein the machine-readable code is encoded with at least the account credentials included in the account profile related to the indicated payment account and the generated transaction cryptogram, wherein the display is further configured to display the identified machine-readable code.

Another mobile communication device for transmitting account credentials via a machine-readable code includes a database, a display, an input device, and a processing device. The database is configured to store at least one account profile, wherein each of the at least one account profile is related to an account and includes at least an integrated circuit card (ICC) public key certificate, an issuer public key certificate, and a mapped account number based on attributes of a real account number associated with the account. The display is configured to display an account listing including each account related to each account profile of the at least one account profile. The input device is configured to receive an indication of an account to be used to conduct a transaction. The processing device is configured to: generate a transaction cryptogram valid for the transaction based on at least one of the ICC public key certificate and issuer public key certificate included in the account profile related to the indicated account; and identify a machine-readable code, wherein the machine-readable code is encoded with at least the mapped account number included in the account profile related to the indicated account and the generated transaction cryptogram, wherein the display is further configured to display the identified machine-readable code.

Yet another mobile communication device for transmitting account credentials via a machine-readable code includes a database, a display, an input device, and a processing device. The database is configured to store a public key and at least one set of account credentials, wherein each set of account credentials is related to an account and includes at least an account number associated with the related account, and the public key corresponds to a private key of an RSA key pair. The display is configured to display an account listing including each account related to each set of account credentials of the at least one set of account credentials. The input device is configured to receive an indication of an account to be used to conduct a transaction. The processing device is configured to: encrypt the account number included in the set of account credentials related to the indicated account using the public key; and identify a machine-readable code, wherein the machine-readable code is encoded with the encrypted account number, wherein the display is further configured to display the identified machine-readable code.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a high level architecture illustrating a system for the display and transmission of account credentials using a mobile device in accordance with exemplary embodiments.

FIG. 2 is a block diagram illustrating the mobile device of FIG. 1 for the display and transmission of account credentials in accordance with exemplary embodiments.

FIG. 3 is a flow chart illustration a method for transmitting account credentials via a second screen of a mobile device in accordance with exemplary embodiments.

FIG. 4 is a flow diagram illustrating a method for generating a replacing a displayed machine-readable code for transmitting account credentials in accordance with exemplary embodiments.

FIG. 5 is a flow diagram illustrating a method for generating and displaying a machine-readable code encoded with account credentials in accordance with exemplary embodiments.

FIGS. 6-8 are flow charts illustrating exemplary embodiments for transmitting account credentials via machine-readable codes displayed by a mobile device in accordance with exemplary embodiments.

FIGS. 9A and 9B are illustrations of a user interface for the selection and display of a machine-readable code encoded with account credentials in accordance with exemplary embodiments.

FIGS. 10A-10C are illustrations of a user interface for the creation of a controlled account number and generation and display of a machine-readable code based thereon in accordance with exemplary embodiments.

FIGS. 11A-11C are illustrations of the changing of machine-readable codes encoded with account credentials displayed on the mobile device for greater account security in accordance with exemplary embodiments.

FIG. 12 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Definition of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, financial accounts, etc. Examples of networks or systems configured to perform as payment networks include those operated by MasterCard®, VISA®, Discover®, American Express®, etc.

Account—An account that may be used to conduct a transaction, such as a financial account used to fund a payment transaction, or track activity for other reasons, such as access control and/or auditing, etc. A financial account may be any type of payment account used to fund a transaction, such as a checking account, savings account, credit account, virtual payment account, etc. A payment account may be associated with an entity, which may include a person, family, company, corporation, governmental entity, etc. In some instances, a payment account may be virtual, such as those accounts operated by PayPal®, etc.

Payment Card—A card or data associated with a payment account that may be provided to a merchant in order to fund a financial transaction via the associated payment account. Payment cards may include credit cards, debit cards, charge cards, stored-value cards, prepaid cards, fleet cards, virtual payment numbers, virtual card numbers, controlled payment numbers, etc. A payment card may be a physical card that may be provided to a merchant, or may be data representing the associated payment account (e.g., as stored in a communication device, such as a smart phone or computer). For example, in some instances, data including a payment account number may be considered a payment card for the processing of a transaction funded by the associated payment account. In some instances, a check may be considered a payment card where applicable. Payment cards may also include real card accounts having associated real card account numbers (RCAs) and mobile cloud accounts having associated mobile cloud account numbers (MCAs) as discussed in more detail herein.

Controlled Payment Number—Controlled payment numbers may be payment numbers associated with a payment account that are subject to one or more rules. In many cases, these rules may be set by a cardholder, such as spending limits, limits on days and/or times of a transaction, limits on merchants or industries, transaction spending or frequency limits, etc. Controlled payment numbers may offer an account holder an opportunity to give payment cards tied to the account to others for use, but subject to rules set by the cardholder, such as an employer distributing cards to employees, or a parent distributing cards to children. Additional detail regarding controlled payment numbers may be found in U.S. Pat. No. 6,636,833, issued Oct. 21, 2003; U.S. Pat. No. 7,136,835, issued Nov. 14, 2006; U.S. Pat. No. 7,571,142, issued Aug. 4, 2009; U.S. Pat. No. 7,567,934, issued Jul. 28, 2009; U.S. Pat. No. 7,593,896, issued Sep. 22, 2009; U.S. patent application Ser. No. 12/219,952, filed Jul. 30, 2008; U.S. patent application Ser. No. 12/268,063, filed Nov. 10, 2008; and U.S. patent application Ser. No. 12/359,971, filed Jan. 26, 2009; each of which are herein incorporated by reference in their entirety.

### System for Transmitting Payment Credentials Via a Mobile Device

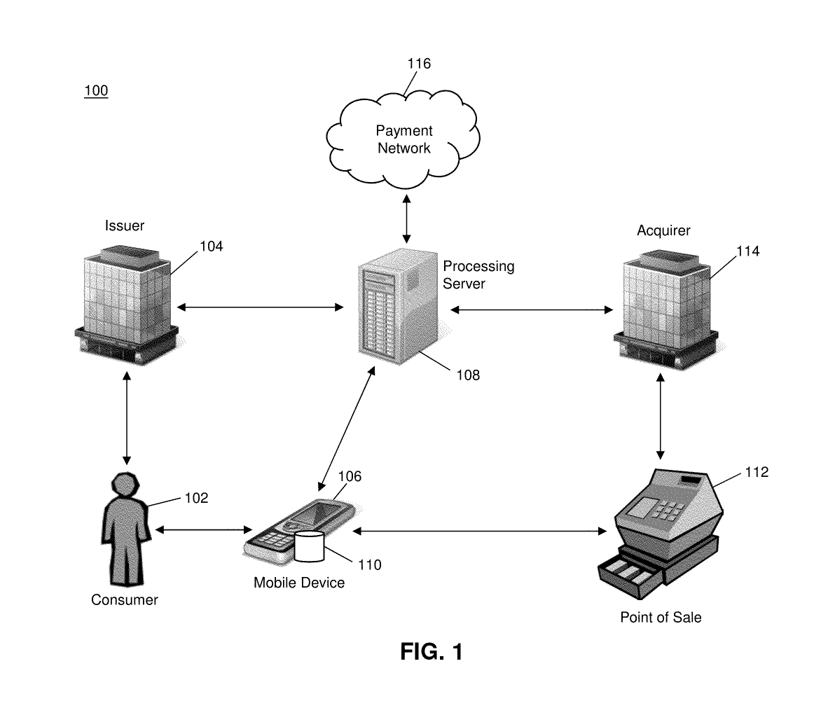

FIG. 1 illustrates a system 100 for the generation of machine-readable codes encoded with payment credentials, the display of such machine-readable codes by a mobile device, and the resulting transmission of the encoded payment credentials.

A consumer 102 may have one or more payment accounts with an issuer 104, such as an issuing bank. Each payment account may have a corresponding account number or other information used for identification of the corresponding payment account. The consumer 102 may also have a mobile device 106 suitable for displaying payment credentials corresponding to the payment accounts, using systems and methods as discussed herein. The mobile device 106 may be any type of mobile communication device suitable for performing the functions as discussed herein, such as a cellular phone, smart phone, tablet computer, laptop computer, etc.

The system 100 may also include a processing server 108. The processing server 108 may be configured to provide payment credentials to the mobile device 106 via a network, such as a mobile communication network or the Internet. The processing server 108 may receive account information from the issuer 104 for the payment accounts associated with the consumer 102, and may generate the payment credentials for transmission to the mobile device 106, as discussed in more detail below. The mobile device 106 may include one or more databases 110, discussed in more detail below, suitable for storing the received payment credentials.

The consumer 102 may visit a location of a merchant and engage in a payment transaction for the purchase of goods or service. As part of the conducting of the payment transaction, the consumer 102 may select one of the payment accounts using the mobile device 106 for funding of the payment transaction. The mobile device 106 may then generate a machine-readable code encoded with the corresponding payment credentials, and display the machine-readable code. In one embodiment, the consumer 102 may select the payment account using a first screen of the mobile device 106, and the machine-readable code may be displayed via a second screen or display of the mobile device 106.

A point of sale 112 at the merchant may be used to read the machine-readable code being displayed by the mobile device 106. The point of sale 112 may then decode the machine-readable code to obtain the payment credentials, and may forward the credentials along with other transaction data to an acquirer 114, such as an acquiring bank. The acquirer 114 may generate an authorization request for the payment transaction including the payment credentials and other transaction data, which it may forward on to the processing server 108. The processing server 108 may then identify the payment account based on the payment credentials, such as by using one of the methods discussed below, and forward the authorization request with the identified payment account to a payment network 116.

The payment network 116 may then process the payment transaction using methods and systems that will be apparent to persons having skill in the relevant art. The payment network 116 may then provide an authorization response, which may be forwarded on to the point of sale 112. The merchant may finalize the payment transaction based on the authorization response (e.g., by furnishing the transaction products to the consumer 102 if the transaction were approved). In some embodiments, the processing server 108 may be a part of the payment network 116.

The transmitting of payment credentials via a machine-readable code rather than near field communication may enable the mobile device 106 to be used for conducting payment transactions using considerably less power and system resources. Furthermore, by not relying on near field communication or a Secure Element, application programs suitable for generating and displaying the machine-readable code may be created and provisioned to the mobile device 106 without cooperation of a network operator, operating system developer, or device manufacturer.

In some embodiments, the mobile device 106 may display the machine-readable code using an electrophoretic display. In such an instance, the electrophoretic display may be able to display the machine-readable code in low- or no-power situations, which may provide for much greater flexibility for the consumer 102 than provided by traditional systems and methods.

In embodiments where the mobile device 106 may include two displays, where the machine-readable code is displayed on a second display, the consumer 102 may be able to continue using the mobile device 106 via the first display, while displaying the machine-readable code on the second display. Not only may this provide easier, and more convenient use to the consumer 102, but it may also enable the mobile device 106 to constantly display a machine-readable code (e.g., which may be secured or continually changed for security purposes using the systems and methods discussed below) without sacrificing usability of the mobile device 106 for much faster, and still more convenient, transactions.

Mobile Device

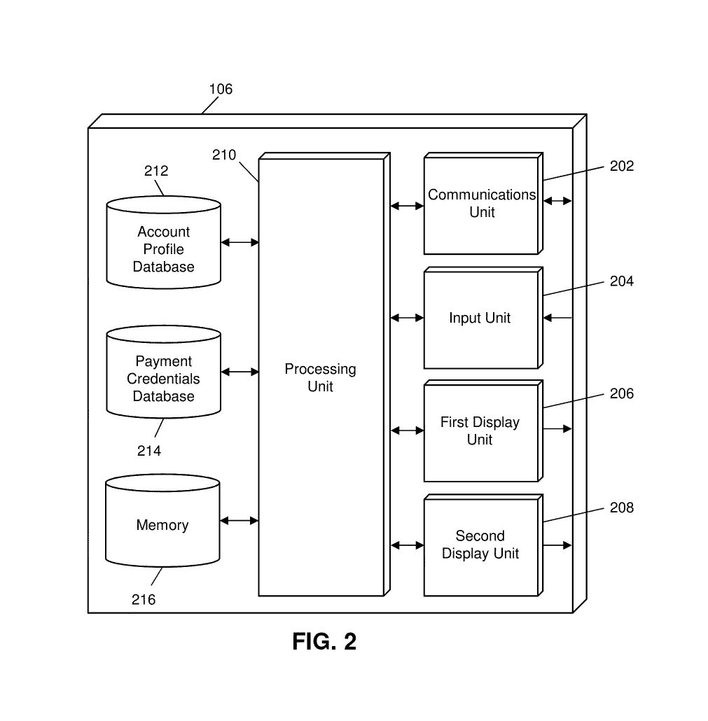

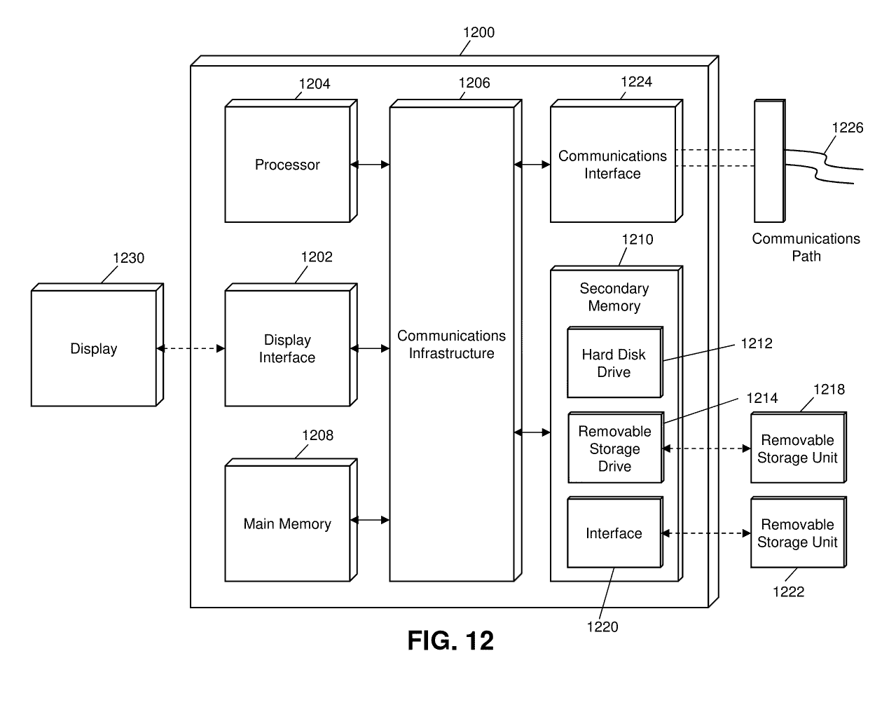

FIG. 2 illustrates an embodiment of the mobile device 106 of the system 100. It will be apparent to persons having skill in the relevant art that the embodiment of the mobile device 106 illustrated in FIG. 2 is provided as illustration only and may not be exhaustive to all possible configurations of the mobile device 106 suitable for performing the functions as discussed herein. For example, the computer system 1200 illustrated in FIG. 12 and discussed in more detail below may be a suitable configuration of the mobile device 106.

The mobile device 106 may include one or more communications units 202. The communications unit 202 may be configured to communicate with one or more networks via one or more network protocols to receive and/or transmit data. For example, the communications unit 202 may be configured to communicate via a mobile communication network or the Internet.

The mobile device 106 may also include one or more input units 204. The input unit 204 may be configured to receive input from the consumer 102. The input unit 204 may be a keyboard, mouse, click wheel, touch screen, microphone, camera, or any other suitable type of input as will be apparent to persons having skill in the relevant art. The input unit 204 may be configured to receive input from the consumer 102 indicating one or more payment accounts to be stored in the mobile device 106 for use in funding payment transactions.

The mobile device 106 may include a processing unit 210. The processing unit 210 may be any type of processor suitable for performing the functions as disclosed herein. The processing unit 210 may be configured process the input received by the input unit 204, such as by storing account information corresponding to accounts indicated by the consumer in an account profile database 212. The account information may include account identifiers, account names, or other information that will be apparent to persons having skill in the relevant art. In one embodiment, the account profile database 212 may not include any payment credentials or other data that may be used to compromise the associated payment accounts.

The communications unit 202 may be configured to communicate with the processing server 108 to request and receive payment credentials for each payment account stored in the account profile database 212. The processing unit 210 may be configured to store the received payment credentials in a payment credentials database 214. The received payment credentials may be encrypted, and may be decrypted or otherwise identified by the processing unit 210 using methods that will be apparent to persons having skill in the relevant art.

The mobile device 106 may include a first display unit 206. The first display unit 206 may be configured to display a payment account listing, which may display each payment account associated with the consumer 102 and stored in the account profile database 212 for selection by the consumer 102 for funding payment transactions. The input unit 204 may be configured to receive input from the consumer 102 indicating one of the displayed payment accounts to be used to fund a payment transaction. The processing unit 210 may then identify payment credentials corresponding to the indicated payment account in the payment credentials database 214. The processing unit 210 may also generate a machine-readable code encoded with identified the payment credentials. In some embodiments, the machine-readable code may be a bar code, such as a QR code, or other optical (visible or otherwise) displayable code. It may be embedded in another image or otherwise not made to be apparent that it is a machine readable code.

The mobile device 106 may include a second display 208, which may be configured to display the generated machine-readable code. In some embodiments, the second display 208 may be an electrophoretic display, or other low energy display and/or long term display. In some instances, the second display 208 may continually display the machine-readable code until instructed otherwise. In one embodiment, the second display 208 may display the machine-readable code even when the mobile device 106 is powered off (e.g., via the electrophoretic display using methods that will be apparent to persons having skill in the relevant art). In still other embodiments, the second display unit 208 displays contents upon activation, for instance by a touch screen or physical switch, and might be activated without disturbing what is displayed on the first display unit 206.

The mobile device 106 may also include a memory 216. The memory 216 may be configured to store additional data as will be apparent to persons having skill in the relevant art. In some instances, the memory 216 may store program code corresponding to one or more application programs to be executed by the processing unit 210. In one instance, one of the application programs may be an electronic wallet program used to perform the functions as disclosed herein.

Transmitting Payment Credentials Using a Second Display

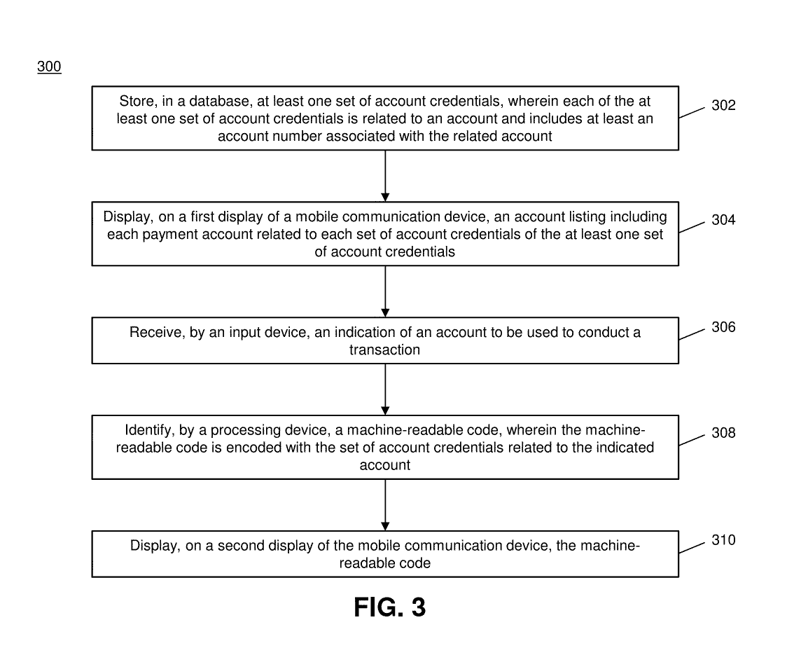

FIG. 3 illustrates a method 300 for transmitting payment credentials via the mobile device 106 using a secondary screen or display.

In step 302, at least one set of account credentials may be stored in a database (e.g., the payment credentials database 214), where each of the at least one set of account credentials is related to an account and includes at least an account number associated with the related account. In step 304, a first display (e.g., the first display unit 206) of a mobile communication device (e.g., the mobile device 106) may display an account listing including each account related to each set of payment credentials of the at least one set of account credentials.

In step 306, an indication of an account to be used to conduct a transaction may be received by an input device (e.g., the input unit 204). In one embodiment, the account may be indicated by the execution of an application program stored in the mobile communication device 106. For example, the mobile device 106 may only store data corresponding to a single account, and thus the single account may be indicated automatically by the opening of an application program programmed to generate and/or display the payment credentials. In such an instance, the account listing may be a listing of the application program to be opened, such as a menu item or icon corresponding to the application program that may be indicated automatically by the opening of the program.

In step 308, a machine-readable code may be identified, by a processing device (e.g., the processing unit 210), wherein the machine-readable code is encoded with the set of account credentials related to the indicated account. In some embodiments, the machine-readable code may be further encoded with at least one of: a name, picture, biometric information, personal identification number, shipping address, loyalty number, and a coupon code. For example, the consumer 102 may provide their fingerprint (e.g., via the first display unit 206 as a capacitive touch screen display), which may also be encoded in the machine-readable code for authentication by the processing server 108, issuer 104, and/or the payment network 116. In one embodiment, the account credentials related to the indicated account encoded in the machine-readable code may be a controlled account number having limitations on use of the controlled account number. In some embodiments, the machine-readable code may be a QR code.

In step 310, the machine-readable code may be displayed on a second display (e.g., the second display unit 208) of the mobile communication device 106. In one embodiment, the second display 208 may be an electrophoretic display. In a further embodiment, the second display 208 may continuously display the machine-readable code until changed or turned off by input via a user (e.g., the consumer 102).

In one embodiment, the method 300 may further include: identifying, after a predetermined period of time, a second machine-readable code, wherein the second machine-readable code is encoded with the set of account credentials and is different from the first machine-readable code; and displaying, on the second display 208 of the mobile communication device 106, the second machine-readable code, wherein data encoded in the machine-readable code expires after the predetermined period of time such that it may not be used to conduct a transaction. In such an instance, the mobile device 106 may thus be able to continually display machine-readable codes encoded with the account credentials, with less risk of compromise of the corresponding account.

### Display and Updating of Payment Credentials

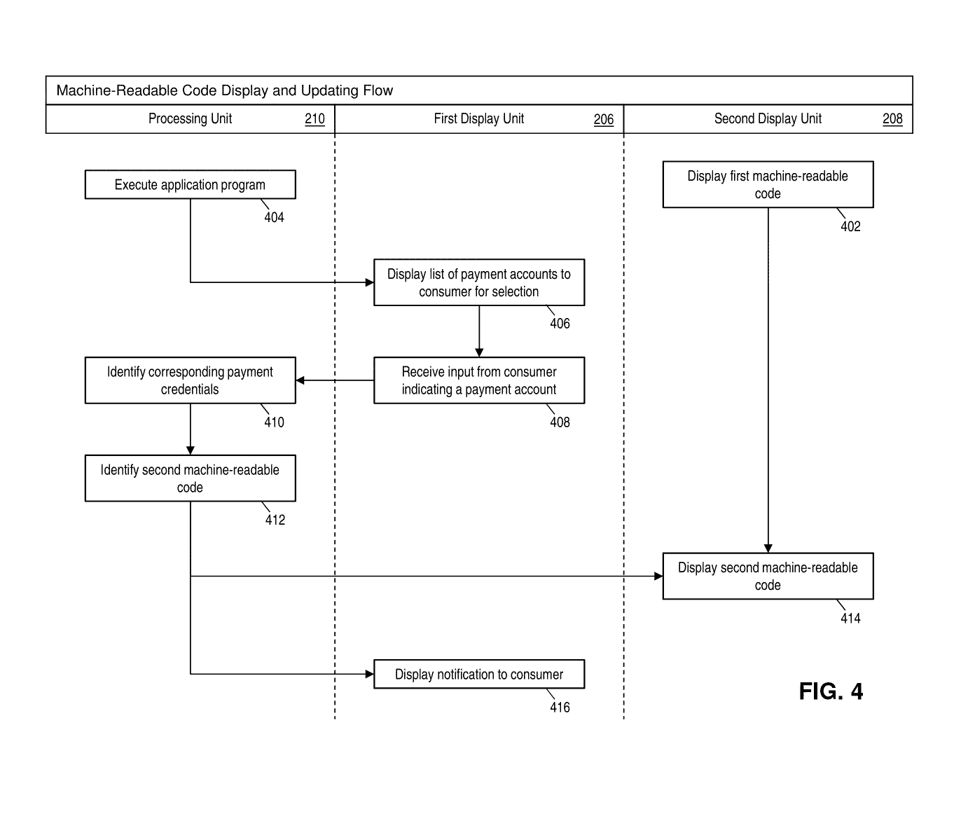

FIG. 4 illustrates a method for the display and updating of a machine-readable code encoded with payment credentials using the mobile device 106.

In step 402, the second display unit 208 may display a first machine-readable code encoded with at least payment credentials for a payment account. In step 404, the processing unit 210 may execute an application program (e.g., stored in the memory 216). In some instances, step 404 may be executed in response to received user input (e.g., the selection of the application program from a list of application programs displayed on the first display unit 206). In step 406, a list of payment accounts may be displayed by the application program via the first display unit 206 for selection by the consumer 102.

Then, in step 408, the first display unit 206 (e.g., or the input unit 204) may receive input from the consumer 102 indicating a payment account included in the payment account listing. In instances where the mobile device 106 may only be associated with a single payment account, the single payment account may be automatically indicated upon execution of the application program in step 404. In step 410, the processing unit 210 of the mobile device 106 may identify payment credentials corresponding to the indicated payment account (e.g., stored in the payment credentials database).

In step 412, the processing unit 210 may identify a second machine-readable code, which may be encoded with the payment credentials identified in step 410. In some embodiments, the second machine-readable code may be encoded with additional data, such as authentication data provided by the consumer 102 (e.g., such as a personal identification number, etc.). In step 414, the second display unit 208 may display the second machine-readable code in place of the first machine-readable code. In step 416, the first display unit 206 may display a notification to the consumer 102 that the machine-readable code displayed via the second display unit 208 has been updated based on their indication. It will be apparent to persons having skill in the relevant art that step 416 may be an optional step.

### Payment Transaction Processing Using Displayed Payment Credentials

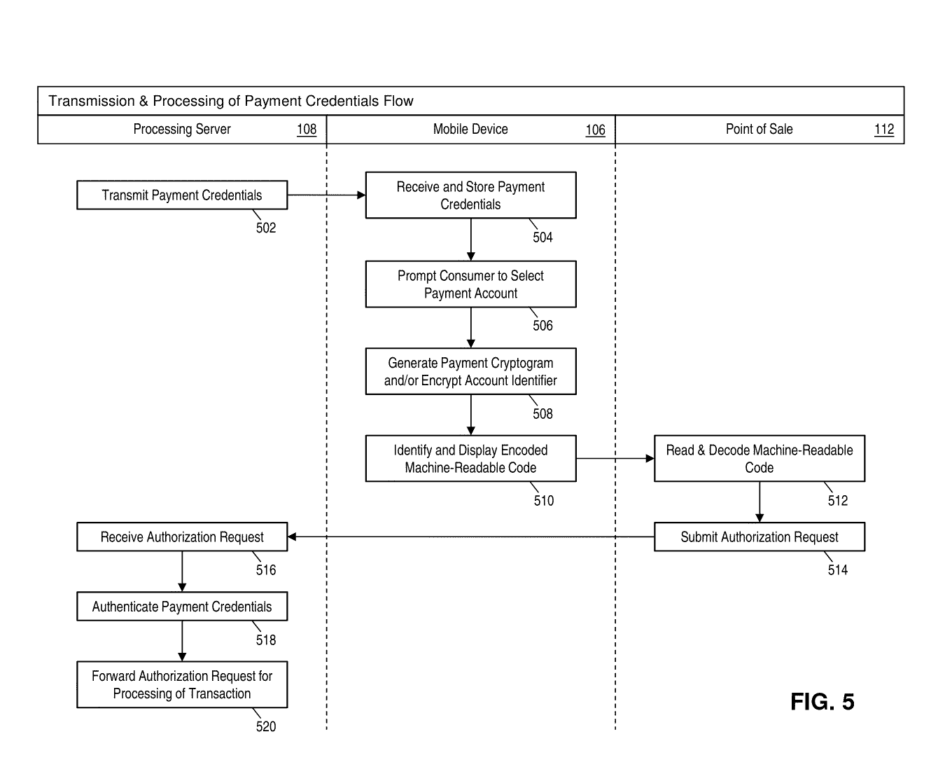

FIG. 5 illustrates a method for the processing of a payment transaction using the payment credentials encoded in the displayed machine-readable code displayed by the mobile device 106.

In step 502, the processing server 108 may transmit payment credentials to the mobile device 106 for one or more payment accounts. In step 504, the mobile device 106 may receive the payment credentials and may store them in the payment credentials database 214. In step 506, the mobile device 106 may (e.g., via the first display unit 206) prompt the consumer 102 to select a payment account for use in funding a payment transaction. The consumer 102 may indicate the payment account via the input unit 204.

In step 508, the mobile device 106 may generate a payment cryptogram and/or encrypt an account identifier corresponding to the indicated payment account. The payment cryptogram and/or encrypted account identifier may be used for authentication of the payment account, as discussed in more detail below. In step 510, the mobile device may identify a machine-readable code encoded with the payment credentials and the payment cryptogram and/or encrypted account identifier, and may display the identified machine-readable code (e.g., via the second display unit 208).

In step 512, the point of sale 112 may read and decode the machine-readable code to obtain the payment credentials and other data. In step 514, the point of sale 112 (e.g., or the acquirer 114 on behalf of the point of sale 112) may submit an authorization request for the payment transaction including the decoded data and any additional transaction data (e.g., transaction amount, etc.) to the processing server 108. In step 516, the processing server 108 may receive the authorization request.

In step 518, the processing server 108 may authenticate the payment credentials using the payment cryptogram and/or encrypted account identifier. Methods suitable for authenticating the payment credentials are discussed in more detail below. Once the credentials are authenticated, then, in step 520, the processing server 108 may forward the authorization request to the payment network 116 for processing of the payment transaction using systems and methods apparent to persons having skill in the relevant art.

First Exemplary Method for Transmitting Payment Credentials

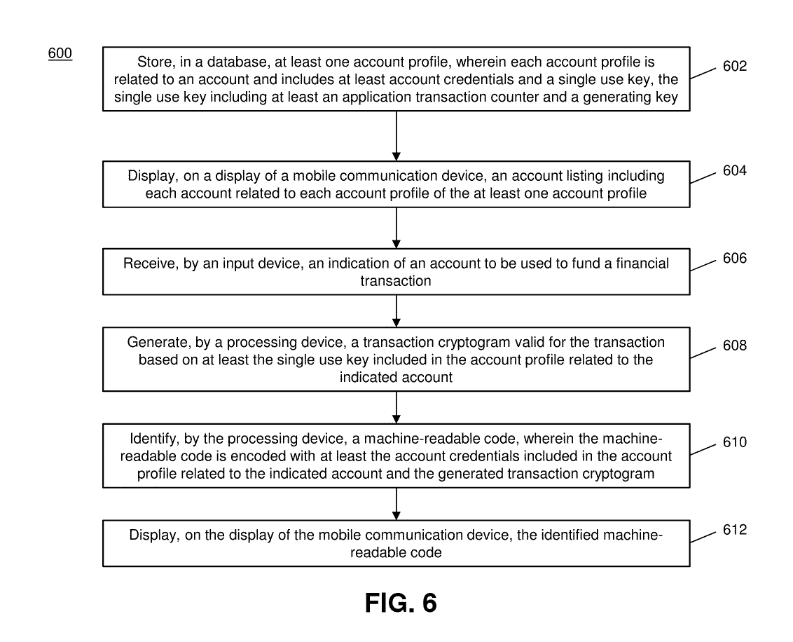

FIG. 6 illustrates a method 600 for transmitting account credentials via machine-readable code.

In step 602, at least one account profile may be stored, in a database (e.g., the account profile database 212), wherein each account profile is related to an account and includes at least account credentials and a single use key, the single use key including at least an application transaction counter and a generating key. In step 604, an account listing may be displayed, on a display (e.g., the first display unit 206) of a mobile communication device (e.g., the mobile device 106), wherein the account listing includes each account related to each account profile of the at least one account profile.

In step 606, an indication of an account to be used to conduct a transaction may be received, by an input device (e.g., the input unit 204). In one embodiment, the indication may be the execution of an application program stored in the mobile communication device. In a further embodiment, the application program may be an electronic wallet program. In step 608, a processing device (e.g., the processing unit 210) may generate a transaction cryptogram valid for the transaction based on at least the single use key included in the account profile related to the indicated account. In one embodiment, the transaction cryptogram may be one of a dynamic card validation code and an authorization request cryptogram.

In step 610, the processing device 210 may identify a machine-readable code, wherein the machine-readable code is encoded with at least the account credentials included in the account profile related to the indicated account and the generated transaction cryptogram. In one embodiment, the machine-readable code may be further encoded with at least one of: a name, picture, biometric information, personal identification number, shipping address, loyalty number, and coupon code. In another embodiment, the encoded account credentials may be a controlled account number having limitations on use of the controlled account number. In some embodiments, the machine-readable code may be a QR code.

In step 612, the identified machine-readable code may be displayed on the display 206 of the mobile communication device. In one embodiment, the account listing may be displayed on a first display 206 of the mobile communication device 106 and the machine-readable code may be displayed on a second display (e.g., the second display unit 208) of the mobile communication device 106. In a further embodiment, the second display 208 may be an electrophoretic display.

Methods and systems suitable for generating a transaction cryptogram (e.g., a payment cryptogram) based on a single use key (e.g., in step 608) and for authenticating accounts (e.g., payment accounts) via the transaction cryptogram can be found in U.S. patent application Ser. No. 13/827,042, entitled “Systems and Methods for Processing Mobile Payments by Provisioning Credentials to Mobile Devices Without Secure Elements,” filed on Mar. 14, 2013, which is hereinafter incorporated by reference in its entirety.

In some embodiments, the method 600 may further include: receiving, by the input device 204, a mobile personal identification number (PIN); transmitting, by a transmitting device (e.g., the communications unit 202), the received mobile PIN and a profile identifier associated with an account profile of the at least one account profile; and receiving, by a receiving device 202, a single use key, wherein the received single use key is received by the receiving device 202 prior to the storing of the single use key, and the received single use key is stored in the account profile associated with the transmitted profile identifier.

Second Exemplary Method for Transmitting Payment Credentials

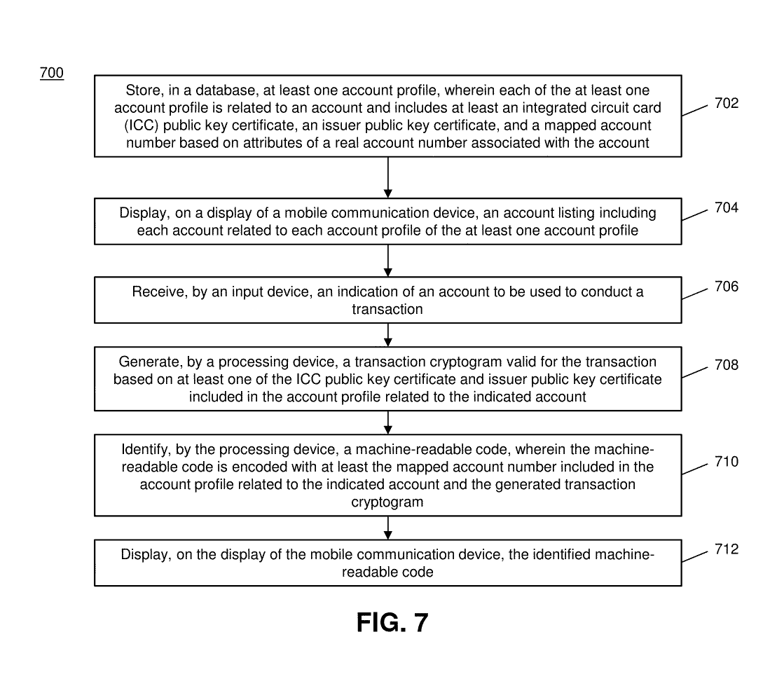

FIG. 7 illustrates a method 700 for transmitting account credentials via machine-readable code.

In step 702, at least one account profile may be stored in a database (e.g., the account profile database 212), wherein each of the at least one account profile is related to an account and includes at least an integrated circuit card (ICC) public key certificate, an issuer public key certificate, and a mapped account number based on attributes of a real account number associated with the payment account. In one embodiment, the mapped account number may include at least a portion of the real account number. In a further embodiment, the portion may include the last four digits of the real account number. In another embodiment, the attributes of the real account number may include at least one of: a brand, product, country code, region, account level management participation, and Durbin indicator.

In step 704, an account listing may be displayed on a display (e.g., the first display unit 206) of a mobile communication device (e.g., the mobile device 106), wherein the account listing includes each account related to each account profile of the at least one account profile. In step 706, an indication of an account to be used to conduct a transaction may be received by an input device (e.g., the input unit 204). In one embodiment, the indication may be the execution of an application program stored in the mobile communication device 106. In a further embodiment, the application program may be an electronic wallet program.

In step 708, a processing device (e.g., the processing unit 210) may generate a transaction cryptogram valid for the transaction based on at least one of the ICC public key certificate and issuer public key certificate included in the account profile related to the indicated account. In one embodiment, the transaction cryptogram may be at least one of: a dynamic card validation code and an authorization request cryptogram.

In step 710, the processing device 210 may identify a machine-readable code, wherein the machine-readable code is encoded with at least the mapped account number included in the account profile related to the indicated account and the generated transaction cryptogram. In one embodiment, the machine-readable code may be further encoded with at least one of: a name, picture, biometric information, personal identification number, shipping address, loyalty number, and coupon code. In some embodiments, the encoded account credentials may include a controlled account number having limitations on use of the controlled account number.

In step 712, the identified machine-readable code may be displayed on the display 206 of the mobile communication device 106. In one embodiment, the account listing may be displayed on a first display 206 of the mobile device 106, and the machine-readable code may be displayed on a second display (e.g., the second display unit 208) of the mobile device 106. In a further embodiment, the second display 208 may be an electrophoretic display.

Methods and systems suitable for generating the transaction cryptogram based on the ICC public key certificate and/or issuer public key certificate (e.g., in step 708) and for the authentication of a payment account based on the generated payment cryptogram, may be found in U.S. patent application Ser. No. 13/782,113, entitled “Systems and Methods for Mapping a Mobile Cloud Account to a Payment Account,” filed on Mar. 1, 2013, which is herein incorporated by reference in its entirety.

Third Exemplary Method for Transmitting Payment Credentials

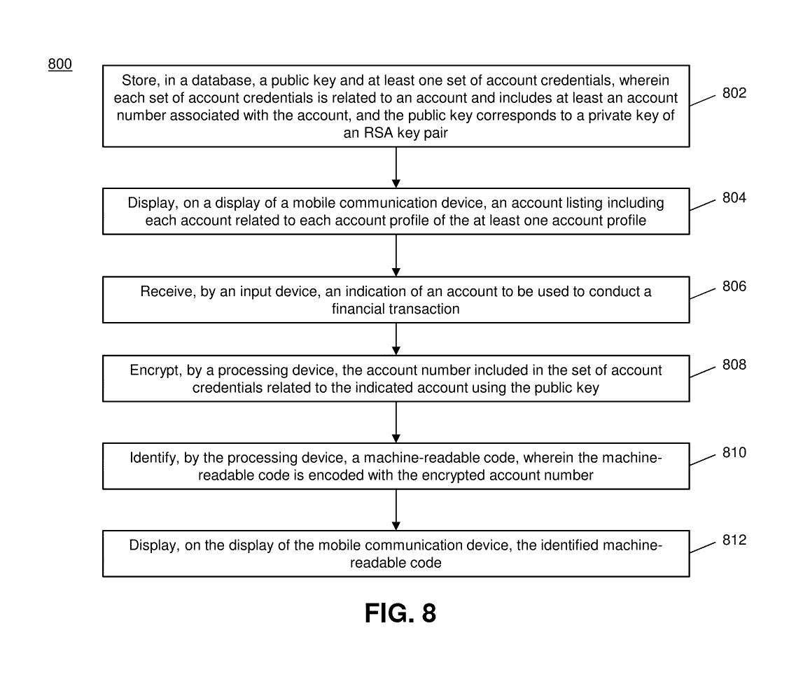

FIG. 8 illustrates a method 800 for transmitting account credentials via machine-readable code.

In step 802, a public key and at least one set of account credentials may be stored in a database (e.g., the payment credentials database 214), wherein each set of account credentials is related to an account and includes at least an account number associated with the corresponding account, and wherein the public key corresponds to a private key of an RSA key pair. In step 804, an account listing may be displayed on a display (e.g., the first display unit 206) of a mobile communication device (e.g., the mobile device 106), wherein the account listing includes each account related to each account profile of the at least one account profile.

In step 806, an input device (e.g., the input unit 204) may receive an indication of an account to be used to conduct a transaction. In one embodiment, the indication may be the execution of an application program stored in the mobile communication device 106. In step 808, a processing device (e.g., the processing unit 210) may encrypt the account number included in the set of account credentials related to the indicated account using the public key. Methods and systems for encrypting a number using a public key of an RSA key pair, and the authentication of the encrypted number thereof based on the private key of the RSA key pair, will be apparent to persons having skill in the relevant art. In one embodiment, encrypting the account number may include padding the account number pursuant to one or more cryptography standards and encrypting the padded account number using the public key. In a further embodiment, the one or more cryptography standards include at least one of: a Public-Key Cryptography Standard and an Optimal Asymmetric Encryption Padding scheme.

In step 810, the processing device 210 may identify a machine-readable code, wherein the machine-readable code is encoded with at least the encrypted account number. In some embodiments, the machine-readable code may be a QR code. In one embodiment, the machine-readable code may be further encoded with at least one of: a name, picture, biometric information, personal identification number, shipping address, loyalty number, and coupon code. In another embodiment, the account credentials may include a controlled account number having limitations on use of the controlled account number.

In step 812, the identified machine-readable code may be displayed on the display 206 of the mobile communication device 106. In one embodiment, the payment account listing may be displayed on a first display 206 of the mobile communication device 106, and the machine-readable code may be displayed on a second display (e.g., the second display unit 208) of the mobile communication device 106. In a further embodiment, the second display 208 may be an electrophoretic display.

### Graphical User Interface

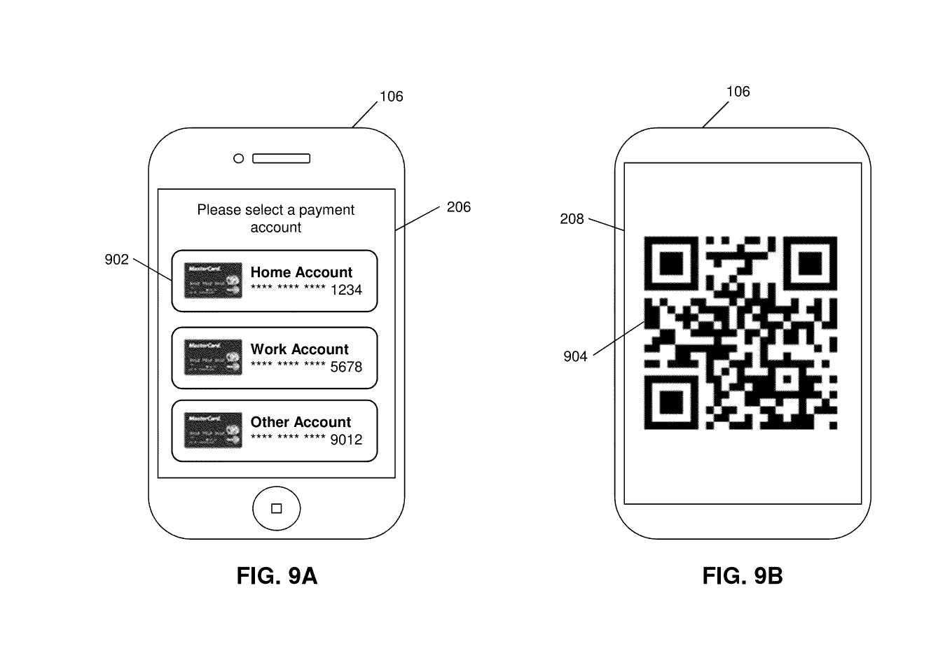

FIGS. 9A, 9B, 10A-10C, and 11A-11C illustrate graphical user interfaces of the mobile device 106. It will be apparent to persons having skill in the relevant art that the interfaces illustrated in the drawings and discussed herein are provided by means of illustration only, and that other interfaces and configurations may be suitable for performing the functions discussed herein.

FIG. 9A is an illustration of the mobile device 106. The mobile device 106 may display, on the first display unit 206, the payment account listing. The payment account listing may list at least one payment account 902 stored in the mobile device 106. As illustrated in FIG. 9A, each payment account listed in the payment account listing may include an account name, an account number (e.g., which may be hidden, obscured, encrypted, etc. for security purposes), and an image associated with the corresponding payment account. The consumer 102 may select (e.g., via the input unit 204) one of the payment accounts 902 included in the payment account listing.

Once the consumer 102 has selected a payment account, the mobile device 106 may generate and/or identify a machine-readable code encoded with the payment credentials for the selected payment account. The mobile device 106 may then display the machine-readable code, such as a QR code 904, on the second display unit 208, as illustrated in FIG. 9B. As illustrated in FIGS. 9A and 9B, in some embodiments, the second display unit 208 may be on the opposite side of the mobile device 106 from the first display unit 206, such that the consumer 102 may continue to perform functions on the mobile device 106 without obscuring the QR code 904.

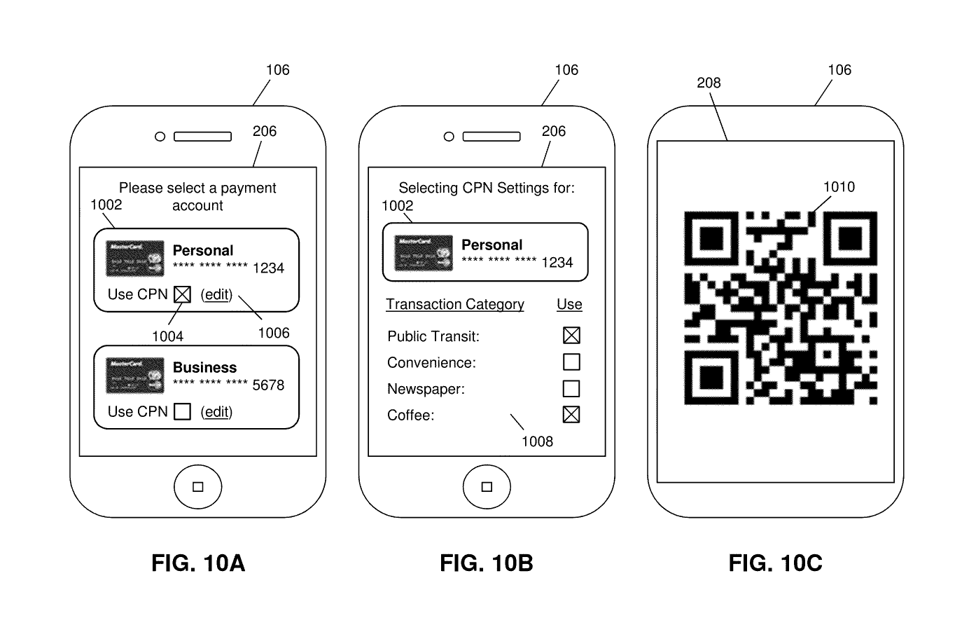

FIGS. 10A-10C illustrate an interface for the transmitting of payment credentials for a payment account using a controlled payment number. As illustrated in FIG. 10A, the payment account listing may include one or more payment accounts 1002, each of which may also include a controlled payment number (CPN) selection box 1004 and an edit link 1006. The CPN selection box 1004, when selected, may cause the mobile device 106 to use a CPN as part of the payment credentials rather than the actual account number associated with the corresponding payment account 1002.

The edit link 1006, when interacted with by the consumer 102, may present options to the consumer 102 for modification of the limits or controls set on the CPN. As illustrated in FIG. 10B, the first display unit 206 may display the selected payment account 1002, and may also display a plurality of controls 1008. Although FIG. 10B illustrates that the CPN corresponding to the payment account 1002 may be controlled via transaction category, additional types of controls and limits will be apparent to persons having skill in the relevant art.

Once the consumer 102 has selected one of the payment accounts 1002 for use, the mobile device 106 may generate and/or identify a QR code 1010 for display on the second display unit 208 of the mobile device 106, as illustrated in FIG. 10C. The point of sale 112 may then read the QR code 1010 and a payment transaction may be processed on the payment account 1002 via the encoded payment credentials, which may include a CPN for the payment account 1002 if indicated in the CPN selection box 1004.

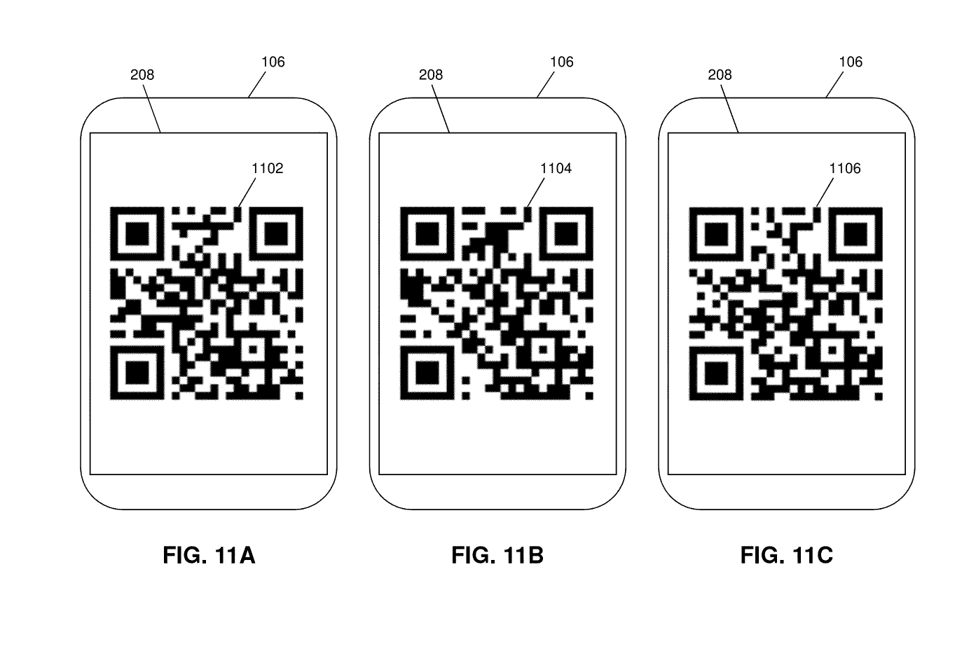

FIGS. 11A-11C illustrate the changing of a machine-readable code displayed by the second display unit 208 on the mobile device 106. The second display unit 208 may display a QR code 1102, which may be encoded with payment credentials for a payment account indicated by the consumer 102. After a predetermined period of time, the mobile device 106 may generate a new machine-readable code, such as a QR code 1104, which may also be encoded with payment credentials for the payment account. The new QR code 1104 may then be displayed by the second display unit 208 in place of the first QR code 1102, as illustrated in FIG. 11B. The new QR code 1104 may itself be replaced after another passage of the predetermined period of time, such as by a QR code 1106, as illustrated in FIG. 11C.

The information encoded in the machine-readable codes may be such that the encoded payment credentials may only be used during the predetermined period of time during which the corresponding machine-readable code is displayed. This may prevent fraud or other misuse of the machine-readable codes. In some instances, the mobile device 106 may encrypt the payment credentials (e.g., an account number of the indicated payment account) using an RSA key pair and based on an additional value that may vary over time. The processing server 108 may possess the other key of the RSA key pair and have knowledge of the additional value. In such an instance, the mobile device 106 may be able to continuously generate new machine-readable codes for display, such as illustrated in FIGS. 11A-11C, which may be secure, yet still result in easily processed payment transactions by the processing server 108 and/or the payment network 116.

### Computer System Architecture

FIG. 12 illustrates a computer system 1200 in which embodiments of the present disclosure, or portions thereof, may be implemented as computer-readable code. For example, the mobile device 106 and the processing server 108 of FIG. 1 may be implemented in the computer system 1200 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3-8.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 1218, a removable storage unit 1222, and a hard disk installed in hard disk drive 1212.

Various embodiments of the present disclosure are described in terms of this example computer system 1200. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 1204 may be a special purpose or a general purpose processor device. The processor device 1204 may be connected to a communication infrastructure 1206, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 1200 may also include a main memory 1208 (e.g., random access memory, read-only memory, etc.), and may also include a secondary memory 1210. The secondary memory 1210 may include the hard disk drive 1212 and a removable storage drive 1214, such as a floppy disk drive, a magnetic tape drive, an optical disk drive, a flash memory, etc.

The removable storage drive 1214 may read from and/or write to the removable storage unit 1218 in a well-known manner. The removable storage unit 1218 may include a removable storage media that may be read by and written to by the removable storage drive 1214. For example, if the removable storage drive 1214 is a floppy disk drive, the removable storage unit 1218 may be a floppy disk. In one embodiment, the removable storage unit 1218 may be non-transitory computer readable recording media.

In some embodiments, the secondary memory 1210 may include alternative means for allowing computer programs or other instructions to be loaded into the computer system 1200, for example, the removable storage unit 1222 and an interface 1220. Examples of such means may include a program cartridge and cartridge interface (e.g., as found in video game systems), a removable memory chip (e.g., EEPROM, PROM, etc.) and associated socket, and other removable storage units 1222 and interfaces 1220 as will be apparent to persons having skill in the relevant art.

Data stored in the computer system 1200 (e.g., in the main memory 1208 and/or the secondary memory 1210) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 1200 may also include a communications interface 1224. The communications interface 1224 may be configured to allow software and data to be transferred between the computer system 1200 and external devices. Exemplary communications interfaces 1224 may include a modem, a network interface (e.g., an Ethernet card), a communications port, a PCMCIA slot and card, etc. Software and data transferred via the communications interface 1224 may be in the form of signals, which may be electronic, electromagnetic, optical, or other signals as will be apparent to persons having skill in the relevant art. The signals may travel via a communications path 1226, which may be configured to carry the signals and may be implemented using wire, cable, fiber optics, a phone line, a cellular phone link, a radio frequency link, etc.

Computer program medium and computer usable medium may refer to memories, such as the main memory 1208 and secondary memory 1210, which may be memory semiconductors (e.g. DRAMs, etc.). These computer program products may be means for providing software to the computer system 1200. Computer programs (e.g., computer control logic) may be stored in the main memory 1208 and/or the secondary memory 1210. Computer programs may also be received via the communications interface 1224. Such computer programs, when executed, may enable computer system 1200 to implement the present methods as discussed herein. In particular, the computer programs, when executed, may enable processor device 1204 to implement the methods illustrated by FIGS. 3-8, as discussed herein. Accordingly, such computer programs may represent controllers of the computer system 1200. Where the present disclosure is implemented using software, the software may be stored in a computer program product and loaded into the computer system 1200 using the removable storage drive 1214, interface 1220, and hard disk drive 1212, or communications interface 1224.

Techniques consistent with the present disclosure provide, among other features, systems and methods for transmitting payment credentials via machine-readable codes. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for transmitting payment credentials, comprising:
storing, in a database, at least one set of account credentials, wherein each of the at least one set of account credentials is related to an account and includes at least an account number associated with the related account;
receiving, by an input device, an indication of an account to be used to conduct a transaction;
identifying, by a processing device, a machine-readable code, wherein the machine-readable code is encoded with the set of account credentials related to the indicated account; and
displaying, on a second display of the mobile communication device, the machine-readable code.

2. The method of claim 1, further comprising:
identifying, after a predetermined period of time, a second machine-readable code, wherein the second machine-readable code is encoded with the set of account credentials and is different from the first machine-readable code; and
displaying, on the second display of the mobile communication device, the second machine-readable code, wherein
data encoded in the machine-readable code expires after the predetermined period of time such that it may not be used to conduct a transaction.

3. The method of claim 1, wherein the machine-readable code is further encoded with at least one of: a name, picture, biometric information, personal identification number, shipping address, loyalty number, and a coupon code.

4. The method of claim 1, wherein the account credentials related to the indicated account encoded in machine-readable code is a controlled account number having limitations on use of the controlled account number.

5. The method of claim 1, wherein the second display is an electrophoretic display.

6. The method of claim 5, wherein the second display continuously displays said machine-readable code until changed or turned off via input by a user.

7. The method of claim 1, further comprising: displaying, on a first display of a mobile communication device, an account listing including each payment account related to each set of account credentials of the at least one set of account credentials.

8. A method for transmitting account credentials via a machine-readable code, comprising:
storing, in a database, at least one account profile, wherein each account profile is related to an account and includes at least account credentials and a single use key, the single use key including at least an application transaction counter and a generating key;
receiving, by an input device, an indication of an account to be used to conduct a transaction;
generating, by a processing device, a transaction cryptogram valid for the transaction based on at least the single use key included in the account profile related to the indicated account;
identifying, by the processing device, a machine-readable code, wherein the machine-readable code is encoded with at least the account credentials included in the account profile related to the indicated account and the generated transaction cryptogram; and
displaying, on the display of the mobile communication device, the identified machine-readable code.

9. The method of claim 8, further comprising:
receiving, by the input device, a mobile personal identification number (PIN);
transmitting, by a transmitting device, the received mobile PIN and a profile identifier associated with an account profile of the at least one account profile; and
receiving, by a receiving device, a single use key,
wherein the received single use key is received by the receiving device prior to the storing of the single use key, and the received single use key is stored in the account profile associated with the transmitted profile identifier.

10. The method of claim 8, wherein the account listing is displayed on a first display of the mobile communication device and the machine-readable code is displayed on a second display of the mobile communication device.

11. The method of claim 10, wherein the second display is an electrophoretic display.

12. The method of claim 8, wherein the transaction cryptogram is one of: a dynamic card validation code and an authorization request cryptogram.

13. The method of claim 8, wherein the machine-readable code is further encoded with at least one of: a name, picture, biometric information, personal identification number, shipping address, loyalty number, and coupon code.

14. The method of claim 8, wherein the account credentials related to the indicated account encoded in machine-readable code is a controlled account number having limitations on use of the controlled account number.

15. The method of claim 8, further comprising: displaying, on a display of a mobile communication device, an account listing including each account related to each account profile of the at least one account profile.

16. A method for transmitting account credentials via a machine-readable code, comprising:
storing, in a database, at least one account profile, wherein each of the at least one account profile is related to an account and includes at least an integrated circuit card (ICC) public key certificate, an issuer public key certificate, and a mapped account number based on attributes of a real account number associated with the account;
receiving, by an input device, an indication of a payment account to be used to conduct a transaction;
generating, by a processing device, a transaction cryptogram valid for the transaction based on at least one of the ICC public key certificate and issuer public key certificate included in the account profile related to the indicated account;
identifying, by the processing device, a machine-readable code, wherein the machine-readable code is encoded with at least the mapped account number included in the account profile related to the indicated account and the generated payment cryptogram; and
displaying, on the display of the mobile communication device, the identified machine-readable code.

17. The method of claim 16, wherein the mapped account number includes at least a portion of the real account number.

18. The method of claim 16, wherein the attributes of the real account number include at least one of: a brand, product, country code, region, account level management participation, and Durbin indicator.

19. The method of claim 16, wherein the transaction cryptogram is one of: a dynamic card validation code and an authorization request cryptogram.

20. The method of claim 16, wherein the account listing is displayed on a first display of the mobile communication device and the machine-readable code is displayed on a second display of the mobile communication device.

21. The method of claim 20, wherein the second display is an electrophoretic display.

22. The method of claim 16, wherein the machine-readable code is further encoded with at least one of: a name, picture, biometric information, personal identification number, shipping address, loyalty number, and coupon code.

23. The method of claim 16, wherein the account credentials related to the indicated account encoded in machine-readable code is a controlled account number having limitations on use of the controlled account number.

24. The method of claim 16, further comprising: displaying, on a display of a mobile communication device, an account listing including each account related to each account profile of the at least one account profile.

25. A method for transmitting account credentials via a machine-readable code, comprising:
storing, in a database, a public key and at least one set of account credentials, wherein each set of account credentials is related to an account and includes at least an account number associated with the related account, and the public key corresponds to a private key of an RSA key pair;
receiving, by an input device, an indication of an account to be used to conduct a transaction;
encrypting, by a processing device, the account number included in the set of account credentials related to the indicated account using the public key;
identifying, by the processing device, a machine-readable code, wherein the machine-readable code is encoded with the encrypted account number; and
displaying, on the display of the mobile communication device, the identified machine-readable code.

26. The method of claim 25, wherein encrypting the account number further includes padding the account number pursuant to one or more cryptography standards and encrypting the padded account number using the public key.

27. The method of claim 26, wherein the one or more cryptography standards includes at least one of: an Public-Key Cryptography Standard and an Optimal Asymmetric Encryption Padding scheme.

28. The method of claim 25, wherein the account listing is displayed on a first display of the mobile communication device and the machine-readable code is displayed on a second display of the mobile communication device.

29. The method of claim 28, wherein the second display is an electrophoretic display.

30. The method of claim 25, wherein the machine-readable code is further encoded with at least one of: a name, picture, biometric information, personal identification number, shipping address, loyalty number, and coupon code.

31. The method of claim 25, wherein the account credentials related to the indicated account encoded in machine-readable code is a controlled account number having limitations on use of the controlled account number.

32. The method of claim 25, further comprising: displaying, on a display of a mobile communication device, an account listing including each account related to each set of account credentials of the at least one set of account credentials.

33. A mobile communication device for transmitting account credentials, comprising:
a database configured to store at least one set of account credentials, wherein each of the at least one set of account credentials is related to an account and includes at least an account number associated with the related account;
a first display configured to display an account listing including at least one account related to each set of account credentials of the at least one set of account credentials;
an input device configured to receive an indication of an account to be used to conduct a transaction;
a processing device configured to identify a machine-readable code, wherein the machine-readable code is encoded with the set of account credentials related to the indicated account; and
a second display configured to display the machine-readable code.

34. The mobile communication device of claim 33, wherein
the processing device is further configured to identify, after a predetermined period of time, a second machine-readable code, wherein the second machine-readable code is encoded with the set of account credentials and is different from the first machine-readable code,
the second display is configured to display the second machine-readable code, and
data encoded in the machine-readable code expires after the predetermined period of time such that it may not be used to fund a financial transaction.

35. The mobile communication device of claim 33, wherein the machine-readable code is further encoded with at least one of: a name, picture, biometric information, personal identification number, shipping address, loyalty number, and a coupon code.

36. The mobile communication device of claim 33, wherein the account credentials related to the indicated account encoded in machine-readable code is a controlled account number having limitations on use of the controlled account number.

37. The mobile communication device of claim 33, wherein the second display is an electronic ink display.

38. The mobile communication device of claim 33, the second display continuously displays said machine-readable code until changed or turned off via input by a user.

39. The mobile communication device of claim 33, wherein the indication of an account to be used to fund the financial transaction is the execution of an application program stored in the mobile communication device.

40. A mobile communication device for transmitting account credentials via a machine-readable code, comprising:
a database configured to store at least one account profile, wherein each account profile is related to an account and includes at least account credentials and a single use key, the single use key including at least an application transaction counter and a generating key;
an input device configured to receive an indication of an account to be used to conduct a transaction; and
a processing device configured to
generate a transaction cryptogram valid for the financial transaction based on at least the single use key included in the account profile related to the indicated account, and
identify a machine-readable code, wherein the machine-readable code is encoded with at least the account credentials included in the account profile related to the indicated account and the generated transaction cryptogram,
wherein the display is further configured to display the identified machine-readable code.

41. The mobile communication device of claim 40, further comprising a transmitting device and a receiving device, wherein
the input device is further configured to receive a mobile personal identification number (PIN),
the transmitting device is configured to transmit the received mobile PIN and a profile identifier associated with an account profile of the at least one account profile,
the receiving device is configured to receive a single use key,
the received single use key is received by the receiving device prior to the storing of the single use key, and
the processing device is configured to store the received single use key in the account profile associated with the transmitted profile identifier.

42. The mobile communication device of claim 40, wherein
the display is comprised of a first display and a second display,
the first display being configured to display the account listing, and
the second display being configured to display the machine-readable code.

43. The mobile communication device of claim 42, wherein the second display is an electrophoretic display.

44. The mobile communication device of claim 40, wherein the transaction cryptogram is one of: a dynamic card validation code and an authorization request cryptogram.

45. The mobile communication device of claim 40, wherein the machine-readable code is further encoded with at least one of: a name, picture, biometric information, personal identification number, shipping address, loyalty number, and coupon code.

46. The mobile communication device of claim 40, wherein the account credentials related to the indicated account encoded in machine-readable code is a controlled account number having limitations on use of the controlled account number.

47. The mobile communication device of claim 40, further comprising: a display configured to display an account listing including each account related to each account profile of the at least one account profile.

48. A mobile communication device for transmitting account credentials via a machine-readable code, comprising:
a database configured to store at least one account profile, wherein each of the at least one account profile is related to an account and includes at least an integrated circuit card (ICC) public key certificate, an issuer public key certificate, and a mapped account number based on attributes of a real account number associated with the account;
an input device configured to receive an indication of an account to be used to conduct a transaction; and
a processing device configured to
generate a transaction cryptogram valid for the financial transaction based on at least one of the ICC public key certificate and issuer public key certificate included in the account profile related to the indicated account, and
identify a machine-readable code, wherein the machine-readable code is encoded with at least the mapped account number included in the account profile related to the indicated account and the generated transaction cryptogram,
wherein the display is further configured to display the identified machine-readable code.

49. The mobile communication device of claim 48, wherein the mapped account number includes at least a portion of the real account number.

50. The mobile communication device of claim 48, wherein the attributes of the real account number include at least one of: a brand, product, country code, region, account level management participation, and Durbin indicator.

51. The mobile communication device of claim 48, wherein the transaction cryptogram is one of: a dynamic card validation code and an authorization request cryptogram.

52. The mobile communication device of claim 48, wherein
the display is comprised of a first display and a second display,
the first display being configured to display the account listing, and
the second display being configured to display the machine-readable code.

53. The mobile communication device of claim 52, wherein the second display is an electrophoretic display.

54. The mobile communication device of claim 48, wherein the machine-readable code is further encoded with at least one of: a name, picture, biometric information, personal identification number, shipping address, loyalty number, and coupon code.

55. The mobile communication device of claim 48, wherein the account credentials related to the indicated payment account encoded in machine-readable code is a controlled account number having limitations on use of the controlled account number.

56. The mobile communication device of claim 48, further comprising: a display configured to display an account listing including each account related to each account profile of the at least one account profile.

57. A mobile communication device for transmitting account credentials via a machine-readable code, comprising:
a database configured to store a public key and at least one set of account credentials, wherein each set of account credentials is related to an account and includes at least an account number associated with the related account, and the public key corresponds to a private key of an RSA key pair;
an input device configured to receive an indication of an account to be used to conduct a transaction; and
a processing device configured to
encrypt the account number included in the set of account credentials related to the indicated payment account using the public key, and
identify a machine-readable code, wherein the machine-readable code is encoded with the encrypted account number,
wherein the display is further configured to display the identified machine-readable code.

58. The mobile communication device of claim 57, wherein the processing device is configured to encrypt the account number by padding the account number pursuant to one or more cryptography standards and encrypting the padded account number using the public key.

59. The mobile communication device of claim 58, wherein the one or more cryptography standards includes at least one of: an Public-Key Cryptography Standard and an Optimal Asymmetric Encryption Padding scheme.

60. The mobile communication device of claim 57, wherein
the display is comprised of a first display and a second display,
the first display being configured to display the account listing, and
the second display being configured to display the machine-readable code.

61. The mobile communication device of claim 60, wherein the second display is an electrophoretic display.

62. The mobile communication device of claim 57, wherein the machine-readable code is further encoded with at least one of: a name, picture, biometric information, personal identification number, shipping address, loyalty number, and coupon code.

63. The mobile communication device of claim 57, wherein the account credentials related to the indicated account encoded in machine-readable code is a controlled account number having limitations on use of the controlled account number.

64. The mobile communication device of claim 57, further comprising: a display configured to display an account listing including each account related to each set of account credentials of the at least one set of account credentials.
